(19) United States
(12) Patent Application Publication
(10) Pub. No.: US 2026/0280140 A1
(43) Pub. Date: Sep. 17, 2026

(54) METHOD FOR SPARSE PLANAR ARRAY SYNTHESIS

(71) Applicant: HARBIN ENGINEERING UNIVERSITY, Harbin, Heilongjiang (CN)

(72) Inventors: Qiang GUO, Harbin, Heilongjiang (CN); Congye LIU, Harbin, Heilongjiang (CN); Yani WANG, Harbin, Heilongjiang (CN); Yong WANG, Harbin, Heilongjiang (CN); Qiaolenaguole LIEANGNIDE, Harbin, Heilongjiang (CN)

(21) Appl. No.: 18/868,380

(22) PCT Filed: Jul. 18, 2023
(86) PCT No.: PCT/CN2023/107829

§ 371 Date: Nov. 22, 2024

(30) Foreign Application Priority Data
May 30, 2023 (CN) 202310627432.4

(51) Int. Cl. H01Q 21/00; G06F 30/27; G06F 111/06; H01Q 3/28; H01Q 3/30

(52) U.S. Cl. CPC H01Q 21/0087; G06F 30/27; H01Q 3/28; H01Q 3/30; G06F 2111/06

(57) ABSTRACT

The present disclosure relates to the field of array antenna synthesis, in particular to a method for sparse planar array synthesis. In order to balance weights of an exploitation process and an exploration process, a nonlinear function reconstruction is used for a math optimizer accelerated in an arithmetic optimization algorithm; the top three optimal individuals are used to replace the current optimal individuals for exploration and exploitation, and an elite variation strategy is introduced to enhance the ability of the algorithm to jump out of local optimum and improve convergence accuracy of the algorithm. An adaptive matrix mapping rule is proposed to judge the current array element distribution. If the current array element distribution does not satisfy a constraint of minimum array element spacing, the current array element distribution is adjusted by an adjustment strategy to ensure the freedom of array elements while avoiding infeasible solutions.

### CROSS-REFERENCE TO RELATED APPLICATION

This patent application is a national stage of International Application No. PCT/CN2023/107829, filed on Jul. 18, 2023, which claims the benefit and priority of Chinese Patent Application No. 202310627432.4 filed with the China National Intellectual Property Administration on May 30, 2023, the disclosure of which is incorporated by reference herein in its entirety as part of the present application.

### TECHNICAL FIELD

The present disclosure relates to the field of array antenna synthesis, in particular to a method for sparse planar array synthesis.

### BACKGROUND

Array synthesis is the research focus in the field of array antennas, and its core is to determine the number of array elements and the excitation phase, the excitation amplitude and the position of each array element according to the required array radiation characteristics. When each array element in the array antennas uses an isotropic radiation array element, the uniform weighted array synthesis can be simplified as the optimization of the position of each array element in the array. At present, there are two main methods to optimize the positions of the array elements. One method is sparse array optimization that only allows the positions of the array elements to appear at given grid points, and the other method is sparse array optimization that each array element can be placed freely under the condition of satisfying the given array aperture and the given array element spacing constraint. Because of the high freedom of the array elements of the sparse array, the expected radiation characteristics can usually be achieved with fewer array elements, which has obvious advantages compared with the sparse array.

The sparse planar array synthesis has always been a difficult problem because of its minimum array element spacing constraint. In order to satisfy the minimum array element spacing constraint, the existing methods for sparse planar array synthesis adjust the positions of the array elements. Although infeasible solutions can be avoided, many array distributions that originally satisfied the minimum array element spacing constraint are forced to be adjusted, which limits the freedom of the array element, and some feasible solutions cannot be searched. In addition, the existing intelligent optimization algorithms have the problems of low searching efficiency and insufficient convergence accuracy in the process of optimizing the array antennas.

In view of the above problems, the method for sparse planar array synthesis based on the improved arithmetic optimization algorithm provided by the present disclosure can ensure the freedom of array elements and improve the optimization accuracy while avoiding infeasible solutions.

### SUMMARY

In order to overcome the problems in the conventional art, the present disclosure provides a method for sparse planar array synthesis.

The technical solution of the present disclosure for solving the technical problems is as follows:

The present disclosure provide a method for sparse planar array synthesis, which specifically includes:
Step 1: by assuming that there are rectangular sparse planar arrays with an array aperture of 2L×2H on an xoy plane, the number of array elements is 4N, and the arrays are symmetrical about x axis and y axis, constructing an initialization population matrix of the rectangular sparse planar arrays;
Step 2: mapping individuals in the initialization population matrix into actual positions of the array elements by using an adaptive matrix mapping rule, and calculating fitness of each individual;
Step 3: calculating a value of a math optimizer accelerated based on the current number of iterations;
Step 4: selecting an exploration update or an exploitation update based on the value of the math optimizer accelerated;
Step 5: performing an elite variation on a globally optimal individual; and
Step 6: if a maximum number of iterations is reached, outputting an optimization result and exiting; otherwise, returning to Step 2.

Further, Step 1 includes: selecting appropriate optimized array matrix dimensions based on an array aperture, in which the optimized array matrix dimensions P and Q need to satisfy:

$$\{ \begin{matrix}P \times Q \geq N \\ P \leq H / {d}_{c} , Q \leq L / {d}_{c}\end{matrix} ;$$

wherein d_{c} is a minimum array element spacing.

Further, the Step 2 specifically includes:
Step 21: providing m individuals in the initialization population matrix, wherein a dimension of each individual is n, and the size of n is 3P×Q; first P×Q variables of each individual are a mapping matrix A∈R^{P×Q} in an x direction, the variables from P×Q+1 to 2P×Q are a mapping matrix B∈R^{P×Q} in a y direction, and last P×Q variables are a weight matrix W∈R^{P×Q};
Step 22: generating a fixed part matrix DX∈R^{P×Q} in the x direction and a fixed part matrix DY∈R^{P×Q} in the y direction based on the minimum array element spacing d_{c} of an optimized array and the matrix dimensions P and Q;
Step 23: determining an actual position matrix X of the array element in the x direction based on the mapping matrix A in the x direction, and determining an actual position matrix Y of the array element in the y direction based on the mapping matrix B in the y direction;
Step 24: calculating the distances between the array elements in different rows and columns based on the actual position of each array element; and if a constraint of the minimum array element spacing is not satisfied, adaptively adjusting the position of the array elements; and
Step 25: calculating the fitness of a current individual based on the actual position of the current array element.

Step 23 specifically includes:
sorting each row of elements of the mapping matrix A in the x direction in an increasing order to form a sorted mapping matrix A′ in the x direction, and combining the sorted mapping matrix A′ with the fixed part matrix DX in the x direction to obtain the actual position matrix X of the array element in the x direction; and
sorting each column of elements of the mapping matrix B in the y direction in an increasing order to form the sorted mapping matrix B′ in the y direction, and combining the sorted mapping matrix B′ with the fixed part matrix DY in the y direction to obtain the actual position matrix Y of the array element in the y direction.

Further, Step 24 specifically includes:
generating an offset matrix B_{offset} based on the mapping matrix B′ in the y direction:

$${B}_{offset} = [ \begin{matrix}0 & 0 & … & 0 \\ {β}_{1 , max} & {β}_{1 , max} & … & {β}_{1 , max} \\ ⋮ & ⋮ & & ⋮ \\ {\sum }_{z = 1}^{P - 1} {β}_{z , max} & {\sum }_{z = 1}^{P - 1} {β}_{z , max} & … & {\sum }_{z = 1}^{P - 1} {β}_{z , max}\end{matrix} ] ;$$

wherein β_{i,max} is a maximum value of each row in the mapping matrix B′ in the y direction, and increases monotonically; and

$${\sum }_{z = 1}^{P - 1} {β}_{z , max}$$

is a maximum value of z row in the sorted mapping matrix B′ in the y direction;

If

$${\sum }_{z = 1}^{P} {β}_{z , max} + ( P - 0.5 ) {d}_{c} > H ,$$

further adjusting the mapping matrix B′ in the y direction and updating the offset matrix B_{offset};

$${B}^{′} = {B}^{′} \times \frac{H - ( P - 0.5 ) {d}_{c}}{{\sum }_{z = 1}^{P} {β}_{z . max}} ,$$

wherein d_{c} is the minimum array element spacing;
after adjustment, the actual position matrix Y of each array element in the y direction is:

$$Y = {B}^{′} + DY + {B}_{offset} .$$

Further, Step 3 specifically includes:
reconstructing a mathematical model of the math optimizer accelerated using a nonlinear function, in which the value of the math optimizer accelerated is:

$$MOA ( G ) = ( Min - Max ) \times {( \frac{G}{{G}_{M}} )}^{2} + Max ;$$

wherein G is the current number of iterations, G_{M} is the maximum number of iterations, and Max and Min are a maximum value and a minimum value of the math optimizer accelerated, respectively.

Further, Step 4 specifically includes:
before each individual is updated, generating a random number r evenly distributed between [0,1], and when r>MOA(G), selecting an exploitation stage, otherwise, selecting an exploration stage, wherein G is the current number of iterations;
in the exploration stage, using a following formula for update:

$${p}_{i , j} ( G + 1 ) = \{ \begin{matrix}leader ( {p}_{j} ) \times MOP \times ( ( {UB}_{j} - {LB}_{j} ) \times μ + {LB}_{j} ) , & r 2 < 0.5 \\ leader ( {p}_{j} ) \div ( MOP + ε ) \times ( ( {UB}_{j} - {LB}_{j} ) \times μ + {LB}_{j} ) , & r 2 \geq 0.5\end{matrix} ;$$

in the exploitation stage, using a following formula for update:

$${p}_{i , j} ( G + 1 ) = \{ \begin{matrix}leader ( {p}_{j} ) - MOP \times ( ( {UB}_{j} - {LB}_{j} ) \times μ + {LB}_{j} ) , & r 3 < 0.5 \\ leader ( {p}_{j} ) + MOP \times ( ( {UB}_{j} - {LB}_{j} ) \times μ + {LB}_{j} ) , & r 3 \geq 0.5\end{matrix} ,$$

$$leader = ( gbest + best 2 + best 3 ) / 3 ;$$

wherein p_{i,j} is an element of a j-th dimension of an i-th individual, LBⱼ and UBⱼ are a lower bound and an upper bound of a searching space of a j-th dimension solution, μ is a constant for controlling optimization; r2 and r3 are random numbers evenly distributed between [0,1]; ε is a very small constant to prevent a divisor from being 0; gbest is a current optimal individual, best2 is a current second optimal individual, and best3 is a current third optimal individual; MOP (Multi-Objective Programming) is a mathematical optimization probabilizer, which is used to control accuracy of exploration and exploitation; and a mathematical model of the MOP is:

$$MOP ( G ) = 1 - \frac{{G}^{1 / σ}}{{G}_{M}^{1 / σ}} ;$$

wherein σ is a sensitivity coefficient, G^{1/σ} is the current number of iterations, and

$${G}_{M}^{1 / σ}$$

is the maximum number of iterations.

Further, Step 5 specifically includes:
randomly selecting two individuals p_{rd1} and p_{rd2} in the population, and performing an elite variation on the globally optimal individual, in which the elite variation individual gbest* is:

$${gbest}^{*} = \{ \begin{matrix}gbest + r 4 ( {p}_{rd 1} - {p}_{rd 2} ) , & if sum ( {p}_{rd 1} - {p}_{rd 2} ) > 0 \\ ( 1 + F \times ( 2 \times r 4 - 1 ) ) \times gbest , & else\end{matrix} ;$$

wherein p_{rd1} and p_{rd2} are two individuals randomly selected in the current population, F is a disturbance coefficient, r4 is a random number evenly distributed between [0,1], and gbest is the current optimal individual; and calculating the fitness of the elite variation individual gbest*, and updating gbest if the elite variation individual is better than the current gbest.

Compared with the conventional art, the present disclosure has the following technical effects.

In the present disclosure, in order to balance the weights of an exploitation process and an exploration process, a nonlinear function reconstruction is used for a math optimizer accelerated in an arithmetic optimization algorithm; the top three optimal individuals are used to replace the current optimal individuals for exploration and exploitation, and an elite variation strategy is introduced to enhance the ability of the algorithm to jump out of local optimum and improve convergence accuracy of the algorithm. An adaptive matrix mapping rule is proposed to judge the current array element distribution. If the current array element distribution does not satisfy a constraint of the minimum array element spacing, the current array element distribution is adjusted by an adjustment strategy to ensure the freedom of array elements while avoiding infeasible solutions.

### BRIEF DESCRIPTION OF THE DRAWINGS

In order to explain the technical solutions and the advantages of the embodiment of the present disclosure or the conventional art more clearly, the drawings required in the description of the embodiment or the conventional art will be briefly introduced hereinafter. Obviously, the drawings in the following description are only some embodiments of the present disclosure. Other drawings can be obtained according to these drawings without creative work for ordinary those skilled in the art.

FIG. 1 is a flowchart of an improved arithmetic optimization algorithm according to the present disclosure.

FIG. 2 is a convergence graph according to the present disclosure.

FIG. 3 is an optimal array element distribution diagram of Experiment 1 according to the present disclosure.

FIG. 4 is a sectional diagram of Experiment 1 in the direction of φ=90° according to the present disclosure.

FIG. 5 is a sectional diagram of Experiment 1 in the direction of φ=0° according to the present disclosure.

FIG. 6 is a three-dimensional diagram corresponding to an optimal array element distribution of Experiment 1 according to the present disclosure.

FIG. 7 is a sectional diagram of Experiment 2 in the direction of φ=0° according to the present disclosure.

FIG. 8 is an optimal array element distribution diagram of Experiment 2 according to the present disclosure.

FIG. 9 is a three-dimensional diagram corresponding to an optimal array element distribution of Experiment 2 according to the present disclosure.

### DETAILED DESCRIPTION OF THE EMBODIMENTS

The present disclosure will be described in further detail with reference to the attached drawings.

In order to further illustrate the technical means and effects used by the present disclosure to achieve the predetermined purpose of the present disclosure, the detailed description, the structures, the features and the effects of the technical solutions proposed according to the present disclosure are described in detail as follows with reference to the attached drawings and preferred embodiments. A particular feature, structure, or characteristic in one or more embodiments may be combined in any suitable form. Unless otherwise defined, all technical and scientific terms used in the present disclosure have the same meaning as commonly understood by those skilled in the technical field of the present disclosure.

Aiming at the problems existing in the conventional art, the present disclosure provides a method for array antennas synthesis based on an improved arithmetic optimization algorithm. First, in order to balance the weights between an exploitation process and an exploration process, a nonlinear function reconstruction is used for a math optimizer accelerated in an arithmetic optimization algorithm. Second, the top three optimal individuals are used to replace the current optimal individuals for exploration and exploitation, and an elite variation strategy is introduced to enhance the ability of the algorithm to jump out of local optimum and improve convergence precision of the algorithm. Finally, an adaptive matrix mapping rule is proposed to judge the current array element distribution. If the current array element distribution does not satisfy a constraint of the minimum array element spacing, the current array element distribution is adjusted by an adjustment strategy to ensure the freedom of array elements while avoiding infeasible solutions.

Referring to FIG. 1, the present disclosure provides a method for sparse planar array synthesis, which specifically includes Steps 1-6.

Step 1: It is assumed that there are rectangular sparse planar arrays with an array aperture of 2L×2H on an xoy plane, the number of array elements is 4N, the arrays are symmetrical about x axis and y axis, the N array elements in a first quadrant are optimized to mirror the array elements in other quadrants, an initialization population matrix of the rectangular sparse planar arrays is constructed.

Appropriate optimized array matrix dimensions are selected based on an array aperture, in which the optimized array matrix dimensions P and Q need to satisfy:

$$\{ \begin{matrix}P \times Q \geq N \\ P \leq H / {d}_{c} , Q \leq L / {d}_{c}\end{matrix} ;$$

wherein d_{c} is a minimum array element spacing.

In order to determine the sparse array elements, a weight matrix W is established, and the size of its dimension is P×Q. N 1s in W represent the reserved array elements, and P×Q−N 0s represent the sparse array elements. The upper bound UB and the lower bound LB of optimization variables are set according to the specific rectangular sparse planar array.

According to the upper bound UB and the lower bound LB of the optimization variables, a population matrix P is randomly initialized, and its mathematical expression is as follows:

$$P = [ \begin{matrix}{p}_{1 , 1} & {p}_{1 , 2} & … & {p}_{1 , n} \\ {p}_{2 , 1} & {p}_{1 , 2} & … & {p}_{1 , n} \\ ⋮ & ⋮ & ⋱ & ⋮ \\ {p}_{m , 1} & {p}_{m , 2} & … & {p}_{m , n}\end{matrix} ] ;$$

wherein P is the initialization population matrix, there are m individuals in the population, p_{m,n} represents the m-th individual, the dimension of the individual is n, and the size of n is 3P×Q.

Step 2: individuals in the initialization population matrix are mapped into actual positions of the array elements by using an adaptive matrix mapping rule, and fitness of each individual is calculated.

This step specifically includes the following steps.

Step 21: m individuals are provided in the initialization population matrix, wherein the dimension of each individual is n, and the size of n is 3P×Q; the optimized variable is an individual in the population, the first P×Q variables of each individual are a mapping matrix A∈R^{P×Q} in the x direction, the variables from P×Q+1 to 2P×Q are a mapping matrix B∈R^{P×Q} in the y direction, and the last P×Q variables are a weight matrix W∈R^{P×Q}; P is the number of array elements in each column of the mapping matrix, and Q is the number of array elements in each row of the mapping matrix;

$$A = [ \begin{matrix}{α}_{1 , 1} & {α}_{1 , 2} & … & {α}_{1 , Q} \\ {α}_{2 , 1} & {α}_{2 , 2} & … & {α}_{2 , Q} \\ ⋮ & ⋮ & & ⋮ \\ {α}_{P , 1} & {α}_{P , 2} & … & {α}_{P , Q}\end{matrix} ] , B = [ \begin{matrix}{β}_{1 , 1} & {β}_{1 , 2} & … & {β}_{1 , Q} \\ {β}_{2 , 1} & {β}_{2 , 2} & … & {β}_{2 , Q} \\ ⋮ & ⋮ & & ⋮ \\ {β}_{P , 1} & {β}_{P , 2} & … & {β}_{P , Q}\end{matrix} ] ;$$

wherein α_{P,Q} represents an element of row P and column Q in the mapping matrix A in the x direction, β_{P,Q} represents an element of row P and column Q in the mapping matrix B in the y direction, the element α in the mapping matrix A in the x direction is a random number in the interval [0,Sₓ], and the element β in mapping matrix B in the y direction is a random number in the interval [0,S_{y}]; Sₓ is the residual Sₓ=L−(Q−0.5)d_{c} of the array element in the x direction; S_{y} is the residual S_{y}=H−(P−0.5)d_{c} of the array element in the y direction, and d_{c} represents the minimum array element spacing.

Step 22: a fixed part matrix DX∈R^{P×Q} in the x direction and a fixed part matrix DY∈R^{P×Q} in the y direction are generated according to the minimum array element spacing d_{c} of the optimized array and the matrix dimensions P and Q. The function of the fixed part matrix is to ensure that the array element spacing of two adjacent array elements in the same row and the same column in the x and y directions satisfies the constraints.

$$DX = [ \begin{matrix}0.5 {d}_{c} & 1.5 {d}_{c} & … & ( Q - 0.5 ) {d}_{c} \\ 0.5 {d}_{c} & 1.5 {d}_{c} & … & ( Q - 0.5 ) {d}_{c} \\ ⋮ & ⋮ & & ⋮ \\ 0.5 {d}_{c} & 1.5 {d}_{c} & … & ( Q - 0.5 ) {d}_{c}\end{matrix} ] , \\ DY = [ \begin{matrix}0.5 {d}_{c} & 0.5 {d}_{c} & … & 0.5 {d}_{c} \\ 1.5 {d}_{c} & 1.5 {d}_{c} & … & 1.5 {d}_{c} \\ ⋮ & ⋮ & & ⋮ \\ ( P - 0.5 ) {d}_{c} & ( P - 0.5 ) {d}_{c} & … & ( P - 0.5 ) {d}_{c}\end{matrix} ] ;$$

wherein the matrix DX∈R^{P×Q} represents the fixed part matrix in the x direction, and the matrix DY∈R^{P×Q} represents the fixed part matrix in the y direction.

Step 23: an actual position matrix X of the array element in the x direction is determined according to the mapping matrix A in the x direction, and an actual position matrix Y of the array element in the y direction is determined according to the mapping matrix B in the y direction.

Each row of elements of the mapping matrix A in the x direction are sorted in an increasing order to form the sorted mapping matrix A′ in the x direction, and the sorted mapping matrix A′ is combined with the fixed part matrix DX in the x direction to obtain the actual position matrix X of the array element in the x direction;

$${A}^{′} = [ \begin{matrix}{α}_{1 , 1}^{′} & {α}_{1 , 2}^{′} & … & {α}_{1 , Q}^{′} \\ {α}_{2 , 1}^{′} & {α}_{2 , 2}^{′} & … & {α}_{2 , Q}^{′} \\ ⋮ & ⋮ & & ⋮ \\ {α}_{P , 1}^{′} & {α}_{P , 2}^{′} & … & {α}_{P , Q}^{′}\end{matrix} ] , s . t . {α}_{i , 1}^{′} \leq {α}_{i , 2}^{′} \leq … \leq {α}_{i , Q}^{′} ( 1 \leq i \leq P ) ,$$

$$X = {A}^{′} + DX ;$$

wherein X represents the actual position matrix of the array element in the x direction, A′ represents the sorted mapping matrix in the x direction, and DX represents the fixed part matrix in the x direction; α′_{P,Q} represents an element of row P and column Q in the sorted mapping matrix in the x direction, a′_{i,1}≤a′_{i,2}≤ . . . ≤a′_{i,Q}, i represents a row, α′_{i,1} represents the element of row i and column 1 in the sorted mapping matrix in the x direction, and α′_{i,Q} represents the element of row i and column Q in the sorted mapping matrix in the x direction.

Each column of elements of the mapping matrix B in the y direction are sorted in an increasing order to form the sorted mapping matrix B′ in the y direction, and the sorted mapping matrix B′ is combined with the fixed part matrix DY in the y direction to obtain the actual position matrix Y of the array element in the y direction;

$${B}^{′} = [ \begin{matrix}{β}_{1 , 1}^{′} & {β}_{1 , 2}^{′} & … & {β}_{1 , Q}^{′} \\ {β}_{2 , 1}^{′} & {β}_{2 , 2}^{′} & … & {β}_{2 , Q}^{′} \\ ⋮ & ⋮ & & ⋮ \\ {β}_{P , 1}^{′} & {β}_{P , 2}^{′} & … & {β}_{P , Q}^{′}\end{matrix} ] , s . t . {β}_{1 , j}^{′} \leq {β}_{2 , j}^{′} \leq … \leq {β}_{P , j}^{′} ( 1 \leq j \leq Q ) ,$$

$$Y = {B}^{′} + DY ;$$

wherein Y represents the actual position matrix of the array element in the y direction, B′ represents the sorted mapping matrix in the y direction, and DY represents the fixed part matrix in the y direction; β′_{P,Q} represents an element of row P and column Q in the sorted mapping matrix in the y direction, j represents a column, β′_{i,1} represents the element of row 1 and column j in the sorted mapping matrix in the y direction, and β′_{P,j} represents the element of row P and column j in the sorted mapping matrix in the y direction.

Step 24: the distances between the array elements in different rows and columns are calculated according to the actual position of each array element; if a constraint of the minimum array element spacing is not satisfied, the position of the array element is adaptively adjusted.

An offset matrix B_{offset} is generated according to the mapping matrix B′ in the y direction:

$${B}_{offset} = [ \begin{matrix}0 & 0 & … & 0 \\ {β}_{1 , max} & {β}_{1 , max} & … & {β}_{1 , max} \\ ⋮ & ⋮ & & ⋮ \\ {\sum }_{z = 1}^{P - 1} {β}_{z , max} & {\sum }_{z = 1}^{P - 1} {β}_{z , max} & … & {\sum }_{z = 1}^{P - 1} {β}_{z , max}\end{matrix} ] ;$$

wherein β_{i,max} is a maximum value of each row in the sorted mapping matrix B′ in the y direction. Because each column of the matrix is incremental, β_{i,max} increases monotonically with the increase of row i;

$${\sum }_{z = 1}^{P - 1} {β}_{z , max}$$

is the cumulative sum of the maximum values of each row in the mapping matrix B′ in the y direction from row 1 to row P−1.

If

$${\sum }_{z = 1}^{P} {β}_{z , max} + ( P - 0.5 ) {d}_{c} > H ,$$

it shows that the direct adjustment of the array element in row P will not satisfy the requirement of the array aperture, so that it is necessary to further adjust the sorted mapping matrix B′ in the y direction and update the offset matrix B_{offset};

$${B}^{′} = {B}^{′} \times \frac{H - ( P - 0.5 ) {d}_{c}}{{\sum }_{z = 1}^{P - 1} {β}_{z . max}} .$$

After adjustment, the actual position matrix Y of each array element in the y direction is:

$$Y = {B}^{′} + DY + {B}_{offset} .$$

The distance between any array elements in two adjacent rows in the y direction is:

$${y}_{i + 1 , m} - {y}_{i , n} = ( {β}_{i + 1 , m}^{′} + ( i + 1 - 0.5 ) {d}_{c} + {\sum }_{z = 1}^{i} {β}_{z , max} ) - ( {β}_{i , n}^{′} + ( i - 0.5 ) {d}_{c} + {\sum }_{z = 1}^{i - 1} {β}_{z , max} ) = {d}_{c} + {β}_{i + 1 , m}^{′} + ( {β}_{i , max} - {β}_{i , n}^{′} ) \geq {d}_{c} + {β}_{i + 1 , m}^{′} \geq {d}_{c} ;$$

wherein y_{i+1,m} and y_{i,n} are the actual positions of the m-th array element in the (i+1)-th row and the n-th array element in the i-th row in the y direction, β′_{i+1,m} and β′_{i,n} are the elements of the (i+1)-th row and the m-th column, and the i-th row and the n-th column in the mapping matrix B′ in the y direction, respectively, and β_{z,max} and β_{i,max} are the maximum values of the z-th row and the i-th row in the mapping matrix B′ in the y direction, respectively.

The distance between adjacent array elements in any row in the x direction is:

$${x}_{i , m + 1} - {x}_{i , m} = {α}_{i , m + 1}^{′} + ( m + 1 - 0.5 ) {d}_{c} - {α}_{i , m}^{′} - ( m - 0.5 ) {d}_{c} = {α}_{i , m + 1}^{′} - {α}_{i , m}^{′} + {d}_{c} \geq {d}_{c} ;$$

wherein x_{i,m+1} and x_{i,m} are the actual positions of the array element in the i-th row and the (m+1)-th column and the array element in the i-th row and the m-th column in the x direction, respectively, α′_{i,m+1} is the residual of the array element in the i-th row and the (m+1)-th column in the x direction, and α′_{i,m} is the residual of the array element in the i-th row and the m-th column in the x direction.

Because the distance between any array elements in two adjacent rows in the y direction and the distance between any array elements in each row in the x direction satisfy the requirement of the minimum array element spacing, the spacing between any two array elements satisfies the requirement of the minimum array element spacing.

The above adjustment strategy is aimed at the situation that the average adjustment residual in the x direction is less than the average adjustment residual in the y direction, that is, Sₓ/Q/S_{y}/P, vice versa.

Step 25: the fitness of the current individual is calculated according to the actual position of the current array element.

Step 3: a value of a math optimizer accelerated MOA is calculated according to the current number of iterations.

A mathematical model of a math optimizer accelerated reconstructed by a nonlinear function is used, in which the value of the math optimizer accelerated MOA is:

$$MOA ( G ) = ( Min - Max ) \times {( \frac{G}{{G}_{M}} )}^{2} + Max ;$$

wherein G is the current number of iterations, G_{M} is the maximum number of iterations, and Max and Min are the maximum value and the minimum value of the MOA, respectively.

Step 4: an exploration update or an exploitation update is selected according to the value of the math optimizer accelerated MOA.

Before each individual is updated, a random number r evenly distributed between [0,1] is generated, and when r>MAO(G), an exploitation stage is selected, otherwise, an exploration stage is selected, wherein G is the current number of iterations.

In the exploration stage, the following formula is used for update:

$${p}_{i , j} ( G + 1 ) = \{ \begin{matrix}leader ( {p}_{j} ) \times MOP \times ( ( {UB}_{j} - {LB}_{j} ) \times μ + {LB}_{j} ) , & r 2 < 0.5 \\ leader ( {p}_{j} ) \div ( MOP + ε ) \times ( ( {UB}_{j} - {LB}_{j} ) \times μ + {LB}_{j} ) , & r 2 \geq 0.5\end{matrix} .$$

In the exploitation stage, the following formula is used for update:

$${p}_{i , j} ( G + 1 ) = \{ \begin{matrix}leader ( {p}_{j} ) - MOP \times ( ( {UB}_{j} - {LB}_{j} ) \times μ + {LB}_{j} ) , & r 3 < 0.5 \\ leader ( {p}_{j} ) + MOP \times ( ( {UB}_{j} - {LB}_{j} ) \times μ + {LB}_{j} ) , & r 3 \geq 0.5\end{matrix} ,$$

$$leader = ( gbest + best 2 + best 3 ) / 3 ;$$

wherein p_{i,j} denotes an element of a j-th dimension of an i-th individual, pⱼ denotes an element of a j-th dimension, LBⱼ and UBⱼ are a lower bound and an upper bound of a searching space of a j-th dimension solution, μ is a constant for controlling optimization, which usually takes the value of 0.499; r2 and r3 are random numbers evenly distributed between [0,1]; ε is a very small constant to prevent a divisor from being 0; gbest is a current optimal individual, best2 is a current second optimal individual, and best3 is a current third optimal individual. MOP (Multi-Objective Programming) is a mathematical optimization probabilizer, and the mathematical model of the MOP is:

$$MOP ( G ) = 1 - \frac{{G}^{1 / σ}}{{G}_{M}^{1 / σ}} ;$$

wherein σ is a sensitivity coefficient, which usually takes the value of 5; MOP is a monotonically decreasing value with the increase of number of iterations, which is used to control the accuracy of exploration and exploitation; G^{1/σ} is the 1/σ power of the current number of iterations G, and

$${G}_{M}^{1 / σ}$$

is the 1/σ power of the maximum number of iterations G_{M}.

Step 5: an elite variation is performed on a globally optimal individual.

In order to further improve the ability of the Angle-of-Arrival (AOA) algorithm to jump out of local optimum and avoid being premature, an elite variation strategy is introduced. In the process of evolution, each generation of populations performs an elite variation on the current best individual. In the early stage of search, elite individuals rely on other individuals in the population for variation. The variation strategy is relatively efficient. In the later stage of search, the variation strategy will be relatively inefficient because of the small difference between individuals.

In order to consider the variation efficiency in both the early and later stages of search, two individuals p_{rd1} and p_{rd2} are randomly selected in the population. The following formula is used for the elite variation:

$${gbest}^{*} = \{ \begin{matrix}gbest + r 4 ( {p}_{rd 1} - {p}_{rd 2} ) , & if sum ( {p}_{rd 1} - {p}_{rd 2} ) > 0 \\ ( 1 + F \times ( 2 \times r 4 - 1 ) ) \times gbest , & else\end{matrix} ;$$

wherein p_{rd1} and p_{rd2} are two individuals randomly selected in the current population, F is a disturbance coefficient, r4 is a random number evenly distributed between [0,1]; the fitness of the elite variation individual gbest* is calculated, and gbest is updated if the elite variation individual is better than the current gbest.

Step 6: if the maximum number of iterations is reached, an optimization result is output to exit the process; otherwise, move to Step 2.

The condition of Experiment 1 of the present disclosure is as follow: the array aperture of the sparse planar array is 2L×2H=9.5λ×4.5λ; the number of array elements is 4N=108; the minimum array element spacing is d₀=0.5λ; the arrays are symmetrical about x axis and y axis; the positions of the array elements in a first quadrant are only optimized to mirror the positions of the array elements in other quadrants; and P is 4, and Q is 9. The number of the populations of the optimization algorithm is 100, the maximum number of iterations is 1000 and 10 independent experiments are conducted. The parameters Max and Min of the improved arithmetic optimization algorithm are 1 and 0.2, respectively. σ, μ and F are 5, 0.499 and 0.03, respectively. The object of optimization is to minimize the sidelobe level sum of the peaks on the two planes of φ=0° and φ=90°, and its fitness function is as follow:

$$fitness ( X , Y , W ) = max \vert \frac{F ( θ , {0}^{o} )}{{FF}_{max}} \vert + max \vert \frac{F ( θ , {90}^{o} )}{{FF}_{max}} \vert ;$$

wherein F(θ, φ) is a pattern function of the array, θ is an azimuth angle, φ is a pitch angle, FFₘₐₓ is the peak of the main lobe, X is the actual position of the array element in the x direction, Y is the actual position of the array element in the y direction, and N 1s in the state matrix W are the reserved array element.

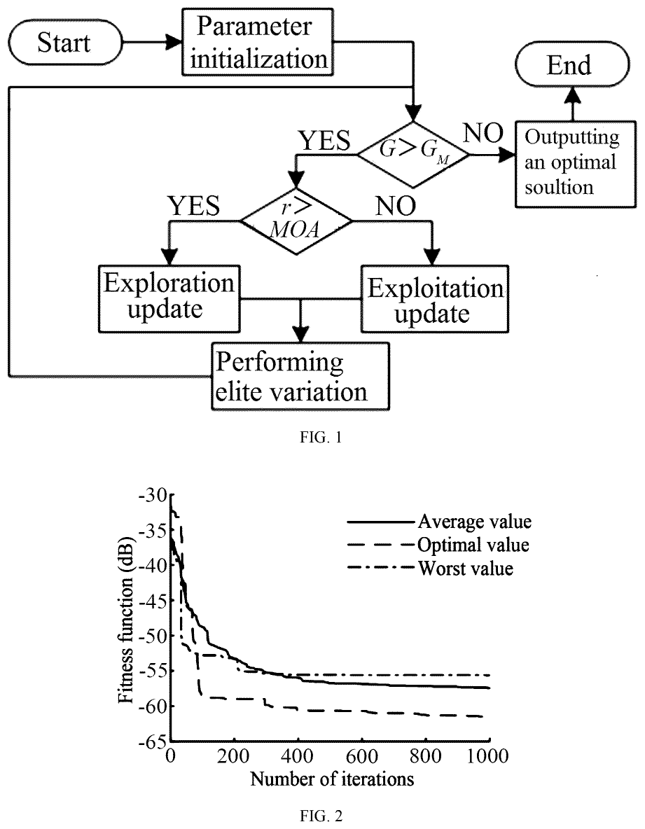

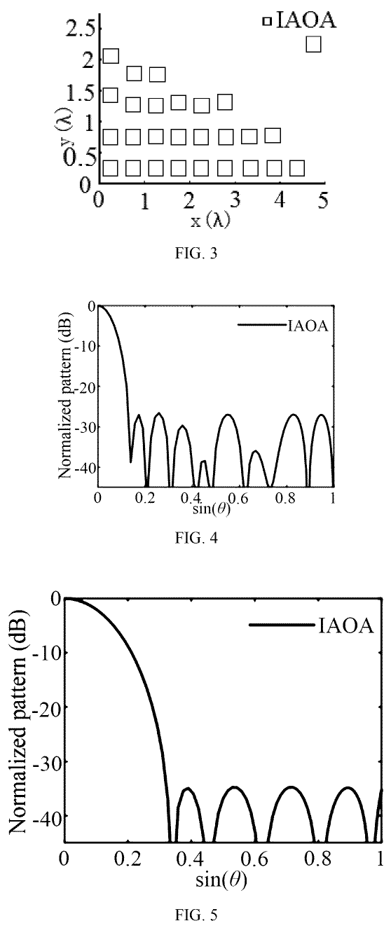

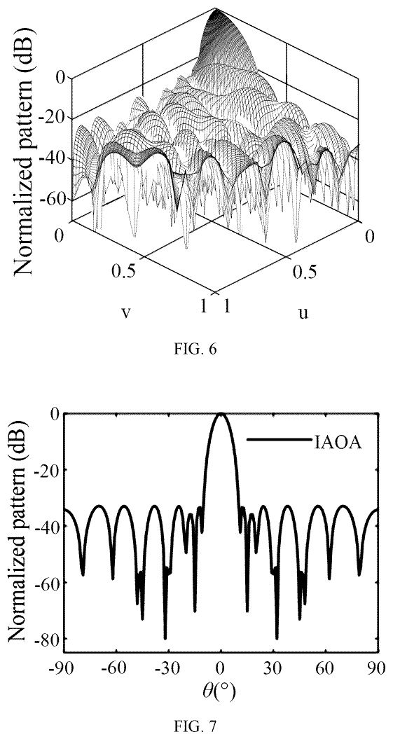

FIG. 2 is a convergence graph of an Improved Arithmetic Optimization Algorithm (IAOA) algorithm. The optimal value of the fitness is −61.47 dB. The sidelobe level of the peak on the plane of φ=0° is −34.78 dB. The sidelobe level of the peak is on the plane of φ=90° is −26.69 dB. The worst value of the fitness is −55.63 dB, and the average value is −57.31 dB. FIG. 3 to FIG. 5 show an optimal array element distribution diagram, a sectional diagram in the direction of φ=90° and a sectional diagram in the direction of φ=0° of different algorithms, respectively. FIG. 6 is a three-dimensional diagram corresponding to the optimal value of the proposed algorithm.

The condition of Experiment 2 of the present disclosure is as follow: the array size of the sparse planar array is 2L×2H=9.5λ×4.5λ; the number of array elements is 4N=100; the minimum array element spacing is d_{c}; the arrays are symmetrical about x axis and y axis; and P is 5, and Q is 9. The object of optimization is to minimize the sidelobe level of the peaks while satisfying the null depth at a specific angle on the specified plane. Two nulls are placed on the plane of φ=0°, which are located at θ=15° and θ=45°, respectively. The expected null depth is −70 dB, and the N-th array element is not fixed. The number of the populations of the optimization algorithm is set as 100. The maximum number of iterations is 1000. 10 independent experiments are conducted. The parameters Max and Min of the improved arithmetic optimization algorithm are 1 and 0.2, respectively. σ, μ and F are 5, 0.499 and 0.03, respectively. The fitness function is as follow:

$$fitness ( X , Y , W ) = c \times max \vert \frac{F ( θ , {0}^{o} )}{{FF}_{max}} \vert + {\sum }_{i = 1}^{M} {c}_{i} \times {error}_{i}^{2} ,$$

$${error}_{i} = \{ \begin{matrix}0 , & if {Null}_{o} < {Null}_{d} \\ {Null}_{o} - {Null}_{d} , & else\end{matrix} ;$$

wherein FFₘₐₓ is the peak of the main lobe, M is the number of placed nulls, c and cᵢ are the weight coefficients which have the unified value of 1, Null_{d} is the expected null depth, and Nullₒ is the actual null depth.

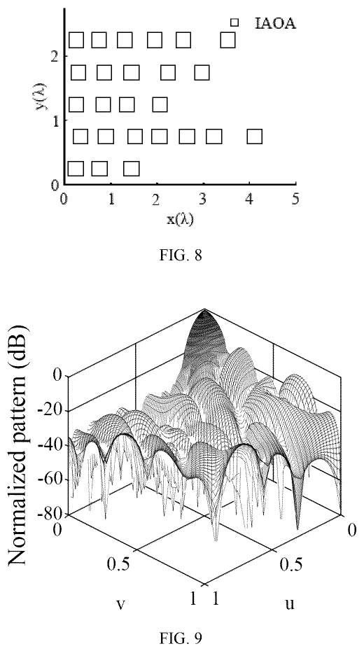

The optimal sidelobe level of the peak obtained by the proposed improved algorithm is −32.68 dB. The null depth at θ=15° is −70.21 dB, and the null depth at θ=45° is −72.98 dB. FIG. 7 and FIG. 8 are the sectional diagram and the optimal array element distribution diagram of the above algorithm in the direction of φ=0°, respectively. FIG. 9 is a three-dimensional diagram corresponding to the optimal value of the proposed algorithm.

To sum up, the method in this embodiment can effectively solve the problems that the current algorithm reduces the freedom of array elements and has low searching efficiency and insufficient convergence accuracy in order to avoid infeasible solutions in sparse planar array synthesis. The improved arithmetic optimization algorithm has the characteristics of strong ability to jump out of local optimum and high convergence accuracy, and the adaptive matrix mapping rule can ensure the freedom of array elements while avoiding infeasible solutions. Compared with the existing algorithms, the proposed method can effectively reduce the sidelobe level of the peak of the sparse planar arrays by 0.75 dB to 3.07 dB and improve the null depth by 0.2 dB to 2.97 dB.

It should be understood that although the steps in the flowcharts involved in the embodiments described above are displayed sequentially as indicated by arrows, these steps are not necessarily executed sequentially as indicated by arrows. Unless explicitly stated in the present disclosure, the execution of these steps is not strictly limited in order, and these steps can be executed in other orders. Moreover, at least a part of the steps in the flowcharts involved in the embodiments described above may include a plurality of steps or a plurality of stages, which may not necessarily be completed at the same time, but may be executed at different times. The execution order of these steps or stages may not necessarily be sequentially executed, but may be alternately executed with other steps or at least a part of steps or stages in other steps.

The above embodiments are only used to illustrate the technical solutions of the present disclosure, rather than limit the technical solutions. Although the present disclosure has been described in detail with reference to the foregoing embodiments, those skilled in the art should understand that it is still possible to modify the technical solutions described in the foregoing embodiments, or to substitute some technical features with equivalents. However, these modifications or substitutions do not make the essence of the corresponding technical solutions deviate from the spirit and scope of the technical solutions of various embodiments of the present disclosure, and should be included in the scope of protection of the present disclosure.

What is claimed is:

1. A method for sparse planar array synthesis comprising:
Step 1: by assuming that there are rectangular sparse planar arrays with an array aperture of 2L×2H on an xoy plane, the number of array elements is 4N, and the arrays are symmetrical about x axis and y axis, constructing an initialization population matrix of the rectangular sparse planar arrays;
Step 2: mapping individuals in the initialization population matrix into actual positions of the array elements by using an adaptive matrix mapping rule, and calculating fitness of each individual;
Step 3: calculating a value of a math optimizer accelerated based on a current number of iterations;
Step 4: selecting an exploration update or an exploitation update based on the value of the math optimizer accelerated;
Step 5: performing an elite variation on a globally optimal individual; and
Step 6: if a maximum number of iterations is reached, outputting an optimization result and exiting; otherwise, returning to Step 2.

2. The method for sparse planar array synthesis according to claim 1, wherein Step 1 comprises: selecting appropriate optimized array matrix dimensions based on an array aperture, in which the optimized array matrix dimensions P and Q need to satisfy:
$$\{ \begin{matrix}P \times Q \geq N \\ P \leq H / {d}_{c} , Q \leq L / {d}_{c}\end{matrix} ;$$
wherein d_{c} is a minimum array element spacing.

3. The method for sparse planar array synthesis according to claim 2, wherein Step 2 comprises:
Step 21: providing m individuals in the initialization population matrix, wherein a dimension of each individual is n, and a size of n is 3P×Q; and for each individual, first P×Q variables are a mapping matrix A∈R^{P×Q} in an x direction, variables from P×Q+1 to 2P×Q are a mapping matrix B∈R^{P×Q} in a y direction, and last P×Q variables are a weight matrix W∈R^{P×Q};
Step 22: generating a fixed part matrix DX∈R^{P×Q} in the x direction and a fixed part matrix DY∈R^{P×Q} in the y direction based on the minimum array element spacing d_{c} of an optimized array and the matrix dimensions P and Q;
Step 23: determining an actual position matrix X of the array element in the x direction based on the mapping matrix A in the x direction, and determining an actual position matrix Y of the array element in the y direction based on the mapping matrix B in the y direction;
Step 24: calculating the distances between the array elements in different rows and columns based on the actual position of each array element; and if a constraint of the minimum array element spacing is not satisfied, adaptively adjusting the position of the array element; and
Step 25: calculating the fitness of a current individual based on the actual position of a current array element.

4. The method for sparse planar array synthesis according to claim 3, wherein Step 23 comprises:
sorting each row of elements of the mapping matrix A in the x direction in an increasing order to form a sorted mapping matrix A′ in the x direction, and combining the sorted mapping matrix A′ with the fixed part matrix DX in the x direction to obtain the actual position matrix X of the array element in the x direction; and
sorting each column of elements of the mapping matrix B in the y direction in an increasing order to form a sorted mapping matrix B′ in the y direction, and combining the sorted mapping matrix B′ with the fixed part matrix DY in the y direction to obtain the actual position matrix Y of the array element in the y direction.

5. The method for sparse planar array synthesis according to claim 4, wherein Step 24 comprises:
generating an offset matrix B_{offset} based on the mapping matrix B′ in the y direction:
$${B}_{offset} = [ \begin{matrix}0 & 0 & … & 0 \\ {β}_{1 , max} & {β}_{1 , max} & … & {β}_{1 , max} \\ ⋮ & ⋮ & & ⋮ \\ {\sum }_{z = 1}^{P - 1} {β}_{z , max} & {\sum }_{z = 1}^{P - 1} {β}_{z , max} & … & {\sum }_{z = 1}^{P - 1} {β}_{z , max}\end{matrix} ] ;$$
wherein β_{i,max} is a maximum value of each row in the mapping matrix B′ in the y direction, and increases monotonically; and
$${\sum }_{z = 1}^{P - 1} {β}_{z , max}$$
is a maximum value of z row in the sorted mapping matrix B′ in the y direction; and
if
$${\sum }_{z = 1}^{P} {β}_{z , max} + ( P - 0.5 ) {d}_{c} > H ,$$
further adjusting the mapping matrix B′ in the y direction and updating the offset matrix B_{offset};
$${B}^{′} = {B}^{′} \times \frac{H - ( P - 0.5 ) {d}_{c}}{{\sum }_{z = 1}^{P} {β}_{z , max}} ;$$
wherein d_{c} is the minimum array element spacing;
wherein, after adjustment, the actual position matrix Y of each array element in the y direction is:
$$Y = {B}^{′} + DY + {B}_{offset} .$$

6. The method for sparse planar array synthesis according to claim 1, wherein Step 3 comprises:
reconstructing a mathematical model of the math optimizer accelerated using a nonlinear function, in which the value of the math optimizer accelerated is:
$$MOA ( G ) = ( Min - Max ) \times {( \frac{G}{{G}_{M}} )}^{2} + Max ;$$
wherein G is the current number of iterations, G_{M} is the maximum number of iterations, and Max and Min are a maximum value and a minimum value of the math optimizer accelerated, respectively.

7. The method for sparse planar array synthesis according to claim 6, wherein Step 4 comprises:
before each individual is updated, generating a random number r evenly distributed between [0,1], and when r>MAO(G), selecting an exploitation stage, otherwise, selecting an exploration stage, wherein G is the current number of iterations;
in the exploration stage, using a following formula for update:
$${p}_{i , j} ( G + 1 ) = \{ \begin{matrix}leader ( {p}_{j} ) \times MOP \times ( ( {UB}_{j} - {LB}_{j} ) \times μ + {LB}_{j} ) , & r 2 < 0.5 \\ leader ( {p}_{j} ) \div ( MOP + ε ) \times ( ( {UB}_{j} - {LB}_{j} ) \times μ + {LB}_{j} ) , & r 2 \geq 0.5\end{matrix} ;$$
in the exploitation stage, using a following formula for update:
$${p}_{i , j} ( G + 1 ) = \{ \begin{matrix}leader ( {p}_{j} ) - MOP \times ( ( {UB}_{j} - {LB}_{j} ) \times μ + {LB}_{j} ) , & r 3 < 0.5 \\ leader ( {p}_{j} ) + MOP \times ( ( {UB}_{j} - {LB}_{j} ) \times μ + {LB}_{j} ) , & r 3 \geq 0.5\end{matrix} ,$$
$$leader = ( gbest + best 2 + best 3 ) / 3 ;$$
wherein p_{i,j} is an element of a j-th dimension of an i-th individual, pⱼ is an element of a j-th dimension, LBⱼ and UBⱼ are a lower bound and an upper bound of a searching space of a j-th dimension solution, μ is a constant for controlling optimization; r2 and r3 are random numbers evenly distributed between [0,1]; ε is a very small constant to prevent a divisor from being 0; gbest is a current optimal individual, best2 is a current second optimal individual, and best3 is a current third optimal individual; MOP is a mathematical optimization probabilizer, which is used to control accuracy of exploration and exploitation; and a mathematical model of the MOP is:
$$MOP ( G ) = 1 - \frac{{G}^{1 / σ}}{{G}_{M}^{1 / σ}} ;$$
wherein σ is a sensitivity coefficient, G^{1/σ} is the current number of iterations, and
$${G}_{M}^{1 / σ}$$
is the maximum number of iterations.

8. The method for sparse planar array synthesis according to claim 1, wherein Step 5 comprises:
randomly selecting two individuals p_{rd1} and p_{rd2} in the population, and performing an elite variation on the globally optimal individual, in which the elite variation individual gbest* is:
$${gbest}^{*} = \{ \begin{matrix}gbest + r 4 ( {p}_{rd 1} - {p}_{rd 2} ) , & if sum ( {p}_{rd 1} - {p}_{rd 2} ) > 0 \\ ( 1 + F \times ( 2 \times r 4 - 1 ) ) \times gbest , & else\end{matrix} ;$$
wherein p_{rd1} and p_{rd2} are two individuals randomly selected in the current population, F is a disturbance coefficient, r4 is a random number evenly distributed between [0,1], and gbest is the current optimal individual; and
calculating the fitness of the elite variation individual gbest*, and updating gbest if the elite variation individual is better than the current gbest.
